(19) United States
(12) Patent Application Publication
(10) Pub. No.: US 2015/0152849 A1
(43) Pub. Date: Jun. 4, 2015

(54) WIND-ENERGY CONVERSION SYSTEMS WITH AIR CLEANERS

(71) Applicant: Sheer Wind, Inc., Chaska, MN (US)

(72) Inventor: Daryoush Allaei, Minnetonka, MN (US)

(73) Assignee: Sheer Wind, Inc., Chaska, MN (US)

(21) Appl. No.: 14/096,077

(22) Filed: Dec. 4, 2013

(51) Int. Cl. F03D 9/00; B01D 45/08; B01D 46/44; B01D 46/00

(52) U.S. Cl. CPC F03D 9/003; B01D 46/0032; B01D 45/08; B01D 46/444

(57) ABSTRACT

A wind-energy conversion system includes a wind-delivery system configured to accelerate wind, an energy extractor configured to output energy in response to receiving the accelerated wind from the wind-delivery system, and an air cleaner configured to clean the wind, e.g., so that cleaned wind exits the wind-energy conversion system.

### FIELD

The present disclosure relates generally to wind-energy conversion, and, in particular, the present disclosure relates to wind-energy conversion systems with air cleaners.

### BACKGROUND

Air pollution is a concern in cities, such as in China, Russia, Japan, Korea, Europe, Mexico, Brazil, the U.S., the Middle East, etc. Various forms of air pollution have increased as these countries have industrialized, which has caused widespread environmental and health problems. Two major sources of air pollution are related to over populated ground transportation and fossil-fuel power generation. Shifting heat and wind-patterns can also affect the concentration of pollutants in the air.

Wind energy is renewable energy source that can reduce the amount of power generated from fossil fuels and thus fossil-fuel-related air pollution. For example, some wind-energy conversion systems involve the wind causing a turbine, located atop a tower, to rotate an electrical generator, resulting in the generation of electrical power.

For the reasons stated above, and for other reasons stated below which will become apparent to those skilled in the art upon reading and understanding the present specification, there is a need in the art for alternatives to existing wind-energy conversion systems.

### SUMMARY

An example of a wind-energy conversion system includes a wind-delivery system configured to accelerate wind, an energy extractor configured to output energy in response to receiving the accelerated wind from the wind-delivery system, and an air cleaner configured to clean the wind, e.g., so that cleaned wind exits the wind-energy conversion system.

### BRIEF DESCRIPTION OF THE DRAWINGS

FIG. 1 is a cutaway perspective view of an example of a wind-delivery system of a wind-energy conversion system, according to an embodiment.

FIG. 2 illustrates an energy-extraction section of a wind-energy conversion system, according to another embodiment.

FIG. 3 is a cutaway view of a nozzle assembly of a wind-energy conversion system, according to another embodiment.

FIG. 4 illustrates an example of an air-cleaning system.

FIG. 5 illustrates an energy-extraction section of a wind-energy conversion system, where the energy-extraction section has one or more non-rotating generators, according to another embodiment.

FIG. 6 illustrates an energy-extraction section of a wind-energy conversion system, where the energy-extraction section has one or more turbines and one or more non-rotating generators, according to another embodiment.

FIG. 7 is an example of an energy extractor having a plurality of non-rotating vibratory generators, according to another embodiment.

FIG. 8 is a cutaway perspective view of a building that includes a wind-energy conversion system, according to an embodiment.

FIG. 9 is an example of a building having a plurality of wind-energy conversion systems, according to another embodiment.

FIG. 10 illustrates a building having a wind-energy conversion system with an air cleaner, according to another embodiment.

FIG. 11 illustrates a cut-away view of a building having a wind-energy conversion system that includes at least one space of the building and that includes an air cleaner, according to another embodiment.

### DETAILED DESCRIPTION

In the following detailed description, reference is made to the accompanying drawings that form a part hereof, and in which is shown, by way of illustration, specific embodiments. In the drawings, like numerals describe substantially similar components throughout the several views. Other embodiments may be utilized and structural changes may be made without departing from the scope of the present disclosure. The following detailed description is, therefore, not to be taken in a limiting sense.

In some examples, a wind-energy conversion system might include an air cleaner or an air-cleaning system that might include an air cleaner. For example, the air cleaner may be configured to clean polluted air (e.g., in the form of wind) by removing pollutants, such as chemicals, particulates, biological materials, and/or smog from the polluted air before the exits the wind-energy conversion system so that the wind-energy conversion system can output cleaned air and electricity.

A wind-energy conversion system might include a wind-delivery (e.g., a wind-intake) system that receives wind (e.g., containing pollutants), accelerates the wind, and delivers accelerated wind to an energy-extraction section that may include an energy extractor configured to output energy in response to receiving wind from the wind-delivery system. The wind-energy conversion system, for example, might be configured to adjust a size and/or shape of at least one of the wind-delivery system and the energy-extraction section based on at least one of a prevailing wind speed external to the wind-energy conversion system, a flow velocity within the wind-energy conversion system, and a power output by the wind-energy conversion system.

The energy extractor may extract energy from the wind for the purpose of generating electricity. For some embodiments, an air cleaner may be in the wind-delivery system, a duct between the wind-delivery system and the energy extractor, or an exhaust duct downstream of (e.g., after) the energy extractor. For example, an air cleaner may be located so that the polluted wind might be cleaned before or after the wind is accelerated or before or after the energy is extracted from the wind so that the wind-energy conversion system can output cleaned air.

An energy extractor might include one or more turbines that convert the kinetic energy of the wind into mechanical (e.g., rotational) energy. The turbine may rotate an electrical generator that generates electrical power. For some embodiments, an energy extractor may include a plurality of turbines in series fluidly coupled to the wind-delivery system.

For other embodiments, an energy extractor might include one or more non-rotating generators that can produce electrical power. For example, a non-rotating generator might be a vibratory generator, e.g., configured to convert the kinetic energy of the wind into vibrational energy. The non-rotating generator may include an electrical-charge-producing material, such as a piezoelectric material, that can produce an electrical charge (e.g., that can output a voltage) when the generator vibrates in response to the wind flowing over the generator. The electrical power may be delivered to a storage battery, directly to an electrical load, and/or to a power grid. For some embodiments, an energy extractor may include a plurality of non-rotating generators in series fluidly coupled to the wind-delivery system. For other embodiments, an energy extractor might include one or more turbines and/or one or more non-rotating generators.

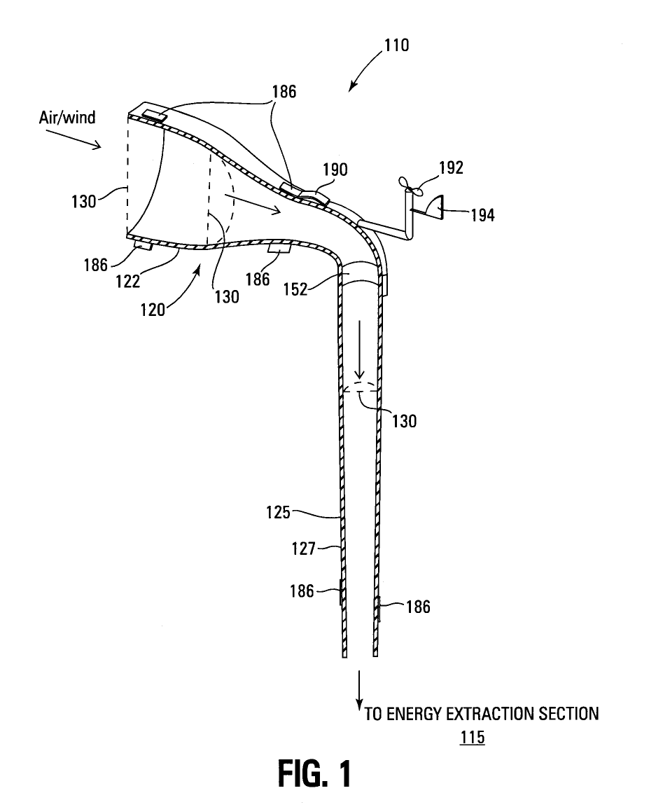

FIG. 1 is a cutaway perspective view of an example of a wind-delivery system 110 of a wind-energy conversion system. In the example of FIG. 1, wind-delivery system 110 includes a nozzle assembly 120 that may include a horizontal converging nozzle 122 that converges in the direction of the wind that flows therethrough during operation. Nozzle assembly 120 may be fluidly coupled to a duct 125. Duct 125 might include a vertical converging nozzle 127 that converges in the direction of the wind that flows therethrough during operation for some embodiments, as shown in FIG. 1. For other embodiments, duct 125 might not include nozzle 127. Nozzle 122 may be rotatably coupled to duct 125, and thus nozzle 127, e.g., by a bearing 152, so that nozzle 122 can rotate relative to duct 125. Nozzle 122 may have a circular, square, rectangular, or any polygonal cross-sectional shape.

As used herein “fluidly coupled” means to allow the flow of fluid (e.g., air/wind). For example, fluid is allowed to flow between fluidly coupled elements, i.e., from one of the fluidly coupled elements to the other. When ducts are fluidly coupled, the flow passages within these ducts are fluidly coupled, for example. It should be recognized the terms vertical or horizontal account variations from “exactly” vertical or “exactly” horizontal due routine manufacturing and/or assembly variations and that one of ordinary skill in the art would know what is meant by the terms vertical and horizontal as used herein.

An air cleaner 130 may be located at the inlet to nozzle 122, and thus to nozzle assembly 120, within nozzle 122, or within duct 125, and thus nozzle 127. Air cleaner 130 may be configured to clean polluted air by removing pollutants, such as chemicals, particulates, biological materials, and/or smog from the air. Air cleaner 130 may include at least one of a mechanical filter and an electrical filter. Non-limiting examples of a mechanical filter may include a HEPA (high-efficiency particulate air) filter, e.g., designed to remove 99.97 percent of airborne particles measuring 0.3 microns or greater in diameter passing through it, an activated carbon filter, etc. Non-limiting examples of an electrical filter filter may include an electrostatic filter and/or an electronic filter, such as the APRILAIRE® Model 5000 from Research Products Corporation (Madison, Wis., U.S.A.).

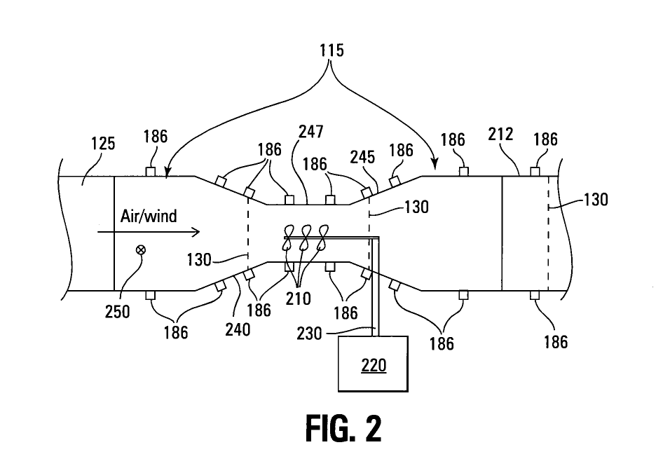

Duct 125, and thus nozzle 127, is fluidly coupled to an energy-extraction section 115, e.g., as shown in FIG. 2. For example, duct 125 fluidly couples nozzle assembly 120 to energy-extraction section 115, e.g., to form a wind-energy conversion system. As such, nozzle 122 accelerates the wind and directs the accelerated wind to nozzle 127. Nozzle 127 further accelerates the wind from nozzle 122 and directs the further accelerated wind to energy-extraction section 115.

FIG. 2 illustrates that for some embodiments, an energy extractor in energy-extraction section 115 may include one or more turbines 210. In an example, the turbines 210 may be in series, as shown in FIG. 2. For example, the turbines 210 in series may be mechanically coupled to an electrical generator 220, such as a rotating generator, by a shaft 230, as shown in FIG. 2. During operation, wind from duct 125 flows over blades of turbines 210, causing the turbines 210 to rotate shaft 230, which in turn rotates generator 220. Generator 220 may be a geared or gearless generator, a high-speed generator, e.g., of the type sometimes used for natural-gas applications, etc. Energy-extraction section 115 might be horizontal or vertical.

For some embodiments, energy-extraction section 115 may include a converging nozzle 240 that is downstream from and that is fluidly coupled to duct 125. Converging nozzle 240 converges in the direction of the wind flow in nozzle 240. Energy-extraction section 115 may include a diffuser 245 that is downstream from and that is fluidly coupled to the one or more turbines 210. Diffuser 245 diverges in the direction of the wind flow in diffuser 245. For example, energy-extraction section 115 may be a Venturi tube for some embodiments, where the Venturi tube includes converging nozzle 240, diffuser 245, and a duct, such as a throat 247, between and fluidly coupled to converging nozzle 240 and diffuser 245, where one or more turbines 210 might be in throat 247.

Nozzle 240 may be between duct 125 and the one or more turbines 210. The one or more turbines 210 may be between nozzle 240 and diffuser 245. For some embodiments, an exhaust duct 212 may be downstream of diffuser 245 and may be fluidly coupled thereto. An air cleaner 130 might be in nozzle 240, diffuser 245, or exhaust duct 212, e.g., instead of being at the inlet to nozzle 122, within nozzle 122, or within duct 125, and thus in nozzle 127.

As best seen in FIG. 1, actuators 186, e.g., piezoelectric actuators, may be physically coupled to at least one of the outer surface of nozzle 122 and to the outer surface of duct 125/nozzle 127. For example, actuators 186 may be coupled in direct physical contact with the outer surface of nozzle 122 and/or the outer surface of duct 125/nozzle 127. Actuators 186 may be communicatively coupled (e.g., electrically coupled, wirelessly coupled, etc.) to a controller 190 for receiving a signal (e.g., an electrical signal over wires, a wireless signal, etc.) from controller 190.

A wind-speed sensor, such as an anemometer 192, may be mounted on wind-delivery system 110. Anemometer 192 may be communicatively coupled (e.g., electrically coupled, wirelessly coupled, etc.) to controller 190 for sending a signal (e.g., an electrical signal over wires, a wireless signal, etc.) to controller 190 indicative of the sensed prevailing wind speed external to the wind-energy conversion system. A wind-direction sensor, such as a wind vane 194, may be mounted on wind-delivery system 110 for sensing the prevailing wind direction. Wind vane 194 catches the wind and rotates nozzle assembly 120 relative to duct 125 such that nozzle assembly 120 is directed into the wind.

For another embodiment, upon receiving a signal (e.g., an electrical signal over wires, a wireless signal, etc.) from wind vane 194, controller 190 may send a signal (e.g., an electrical signal over wires, a wireless signal, etc.) to a yaw motor (not shown) located adjacent to bearing 152. A yaw drive (not shown) may mechanically couple the yaw motor to nozzle assembly 120. The signal instructs the yaw motor to activate the yaw drive that in turn rotates nozzle assembly 120 such that nozzle assembly 120 is directed into the wind.

In response to receiving a signal, indicative of the prevailing wind speed external to the wind-energy conversion system, from anemometer 192, controller 190 may send a signal (e.g., an electrical signal over wires, a wireless signal, etc.) based on the prevailing wind speed to actuators 186. Actuators 186 may then adjust the size (e.g., of the flow passage of) and/or shape of nozzle 122 and/or the size (e.g., of the flow passage of) and/or shape of duct 125/nozzle 127 by exerting forces directly on the outer surface of nozzle 122 and/or the outer surface of duct 125/nozzle 127 based on the prevailing wind speed. That is, the size and/or shape of nozzle 122 and/or the size and/or shape duct 125/nozzle 127 may be adjusted based on the prevailing wind speed. For example, actuators 186 may adjust one or more diameters of nozzle 122 and/or one or more diameters of duct 125/nozzle 127.

Actuators 186 might be coupled to converging nozzle 240, diffuser 245, and/or throat 247 of energy-extraction section 115, e.g., in direct physical contact with an outer surface of converging nozzle 240, diffuser 245, throat 247, and/or exhaust duct 212, as shown in FIG. 2. These actuators 186 may be communicatively coupled (e.g., electrically coupled, wirelessly coupled, etc.) to controller 190. Actuators 186 are configured to adjust the size (e.g., of the flow passage of) and/or shape of converging nozzle 240, diffuser 245, and/or throat 247 of energy-extraction section 115 and/or exhaust duct 212 by exerting forces directly on the outer surfaces of converging nozzle 240, diffuser 245, throat 247, and/or exhaust duct 212 in response to receiving a signal (e.g., an electrical signal over wires, a wireless signal, etc.) from controller 190 based on the prevailing wind speed external to the wind-energy conversion system, e.g., based on a signal received at controller 190 from anemometer 192 indicative of the prevailing wind speed.

Controller 190 may be communicatively coupled (e.g., electrically coupled, wirelessly coupled, etc.) to electrical generator 220 and may be configured to monitor the power output from electrical generator 220. Actuators 186 may adjust the size and/or shape of nozzle 122 (FIG. 1), the size and/or shape of duct 125/nozzle 127 (FIG. 1), the size and/or shape of converging nozzle 240 (FIG. 2), the size and/or shape of diffuser 245 (FIG. 2), the size and/or shape of throat 247 (FIG. 2), and/or the size and/or shape of exhaust duct 212 (FIG. 2) by exerting forces directly on the outer surface of nozzle 122, the outer surface of duct 125/nozzle 127, the outer surface of converging nozzle 240, the outer surface of diffuser 245, the outer surface of throat 247, and/or the outer surface of exhaust duct 212 in response to receiving a signal from controller 190 based on the power output.

For example, the signal from controller 190 might cause actuators 186 to increase the size of nozzle 122, the size of duct 125/nozzle 127, the size of converging nozzle 240, the size of diffuser 245, the size of throat 247, and/or the size of exhaust duct 212 in response to power output dropping below a certain level. The power output dropping below a certain level might be due to an increase in pressure drop due to an air cleaner 130 and/or a drop in the prevailing wind speed external to the wind-energy conversion system. For example, the increase in pressure drop and/or the drop in the prevailing wind speed may reduce the flow velocity (e.g., flow rate) of the air/wind in the wind-energy conversion system, and the increased size of nozzle 122, duct 125/nozzle 127, converging nozzle 240, diffuser 245, throat 247, and/or exhaust duct 212 may compensate for the drop in the prevailing wind speed by acting to increase the flow velocity in the wind-energy conversion system.

A sensor 250, such as a flow-velocity (e.g., flow-rate sensor), might be located in energy-extraction section 115, e.g., upstream of converging nozzle 240 or in duct 125, for measuring the flow velocity (e.g., the flow rate) of the air/wind in energy-extraction section 115 or duct 125, e.g., within the wind-energy conversion system. Sensor 250 may be communicatively coupled (e.g., electrically coupled, wirelessly coupled, etc.) to controller 190 for sending a signal (e.g., an electrical signal over wires, a wireless signal, etc.) to controller 190 indicative of the flow velocity, e.g., within the wind-energy conversion system.

A signal from controller 190 might cause actuators 186 to increase the size of nozzle 122, the size of duct 125/nozzle 127, the size of converging nozzle 240, the size of diffuser 245, the size of throat 247, and/or the size of exhaust duct 212 in response to controller 190 receiving a signal from sensor 250 indicative of the flow velocity dropping below a certain level. For example, the increased size of nozzle 122, duct 125/nozzle 127, converging nozzle 240, diffuser 245, throat 247, and/or exhaust duct 212 might compensate for a reduction in the velocity due to the added pressure drop due to the presence of an air cleaner 130 or due to a drop in the prevailing wind speed external to the wind-energy conversion system by acting to increase the flow velocity in the wind-energy conversion system.

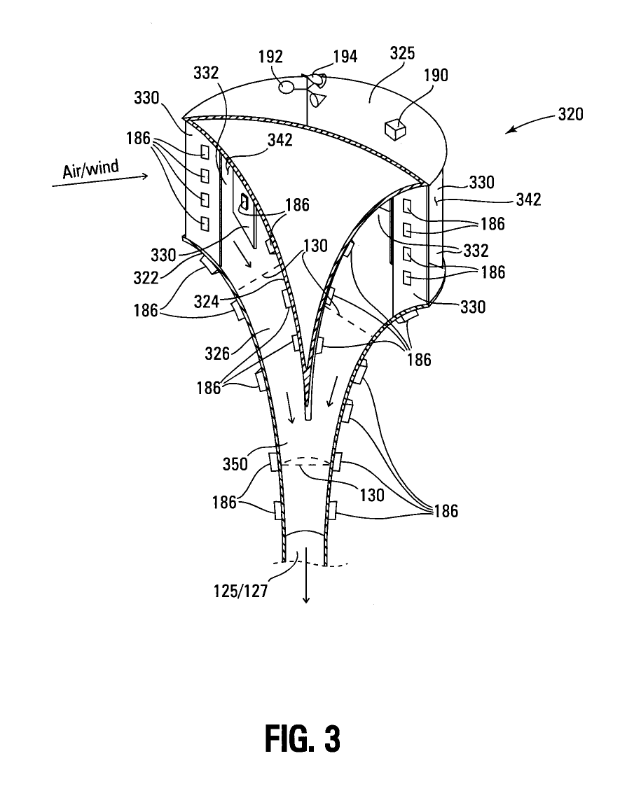

FIG. 3 is a cutaway view of a nozzle assembly 320 that may replace nozzle assembly 120 of wind-delivery system 110 in FIG. 1, in some embodiments, so that wind-delivery system 110 now includes nozzle assembly 320 instead of nozzle assembly 120. For example, nozzle assembly 320 may be fluidly coupled to duct 125, and thus nozzle 127 for embodiments where duct 125 includes nozzle 127 (FIG. 1). Duct 125 fluidly couples nozzle assembly 320 to energy-extraction section 115 to form a wind-energy conversion system.

Nozzle assembly 320 may include a vertical converging nozzle 322 and an object, such as a deflector 324, extending into nozzle 322. Nozzle assembly 320 may include a converging flow passage 326 between deflector 324 and nozzle 322. Deflector 324 deflects wind into nozzle 322. Intake assembly 320 may include a cover 325 over (e.g., as a portion of) deflector 324.

Wind may enter nozzle assembly 320 at substantially any direction, such as at substantially 360 degrees (e.g., at 360 degrees) around nozzle assembly 320. This avoids the need for turning an inlet of a wind-energy conversion system or a turbine of a wind-energy conversion system into the wind, e.g., thereby eliminating the need for yaw system.

There may be a plurality of vanes 330 between deflector 324 and nozzle 322. There may be a plurality of flow passages 332, where each flow passage 332 is between adjacent vanes 330. The plurality of flow passages 332 open into flow passage 326.

For some embodiments, actuators 186 may be physically coupled to one or more of vanes 330, as shown in FIG. 3, and may be communicatively coupled to controller 190 for receiving a signal from controller 190. For example, actuators 186 may be coupled in direct physical contact with the surfaces of vanes 330. Actuators 186 may also be coupled in direct physical contact with the outer surface of deflector 324 and/or in direct physical contact with the outer surface of nozzle 322, as shown in FIG. 3, and may be communicatively coupled to controller 190 for receiving a signal from controller 190. In other words, for example, one or more actuators 186 may be coupled to at least one of the outer surface of deflector 324, the outer surface of nozzle 322, and the surfaces of one or more vanes 330.

In response to receiving the signal indicative of the prevailing wind speed from anemometer 192, the air/wind velocity from sensor 250, and/or the power output from generator 220, controller 190 may send a signal (e.g., an electrical signal over wires, a wireless signal, etc.) to actuators 186. For example, the signal sent to actuators 186 from controller 190 may be based on the prevailing wind speed external to the wind-energy conversion system, as indicated by anemometer 192 (FIG. 3), the air/wind speed in duct 125 or energy-extraction section 115 (e.g., internal to the wind-energy conversion system) as indicated by sensor 250 (FIG. 2), and/or the power output from the wind-energy conversion system.

The actuators 186 coupled to deflector 324 may then adjust the size and/or shape (e.g., the amount of convergence) of deflector 324 by exerting forces directly on the outer surface of deflector 324, in response to receiving the signal from controller 190. That is, for example, the size and/or shape of deflector 324 may be adjusted based on the prevailing wind speed external to the wind-energy conversion system, the air/wind speed internal to the wind-energy conversion system, and/or the power output from the wind-energy conversion system.

The actuators 186 coupled to nozzle 322 may then adjust the size and/or shape of nozzle 322 by exerting forces directly on the outer surface of nozzle 322, in response to receiving the signal from controller 190. That is, for example, the size and/or shape of nozzle 322 may be adjusted based on the prevailing wind speed external to the wind-energy conversion system, the air/wind speed internal to the wind-energy conversion system, and/or the power output from the wind-energy conversion system.

For example, the size and/or shape of the flow passage 326 between deflector 324 and nozzle 322 may be adjusted by adjusting the size and/or shape of deflector 324 using the actuators 186 coupled to deflector 324 and/or by adjusting the size and/or shape of nozzle 322 using the actuators 186 coupled to nozzle 322. In addition, the turning radius (e.g., the radius of curvature) of the flow passage 326 may be adjusted by adjusting the actuators 186 coupled to deflector 324 and/or nozzle 322. Note that the actuators 186 coupled to nozzle 322 may also adjust the size and/or shape of a flow passage 350 of nozzle 322 that is between and fluidly coupled to flow passage 326 and the flow passage of duct 125/nozzle 127 in response to receiving the signal from controller 190.

The actuators 186 coupled to successively adjacent vanes 330 may adjust the size and/or shape (e.g., the amount of convergence) of a flow passage 332 between the successively adjacent vanes 330 by exerting forces directly on the surfaces of the successively adjacent vanes 330 based on the prevailing wind speed external to the wind-energy conversion system, the air/wind speed internal to the wind-energy conversion system, and/or the power output from the wind-energy conversion system. Controller 190 may send a signal (e.g., an electrical signal over wires, a wireless signal, etc.) to the actuators 186 coupled to vanes 330. The actuators 186 coupled to vanes 330 may then adjust the size and/or shape of each flow passage 332 between successively adjacent vanes 330 by exerting forces directly on the surface of vanes 330 in response to receiving the signal from controller 190. Note that the signal from controller 190 may be based on the prevailing wind speed external to the wind-energy conversion system, the air/wind speed internal to the wind-energy conversion system, and/or the power output from the wind-energy conversion system.

During operation, wind (e.g., containing pollutants) is received at an inlet 342 of one or more flow passages 332. As the wind flows through the one or more flow passages 332, it converges and thus accelerates. As the accelerating wind flows through the one or more flow passages 332, it may be turned by the curvature of the respective flow passage 332, e.g., toward a vertical downward direction. The accelerated wind is then received in flow passage 326 from the one or more flow passages 332, and converges, and is thus further accelerated, as it flows through flow passage 326. The further accelerated wind is then received in flow passage 350 of nozzle 322 from flow passage 326. As the wind flows through flow passage 350, it converges and thus further accelerates. The wind flows from flow passage 350 into duct 125 that in turn delivers the wind to energy-extraction section 115. In the event that duct 125 includes nozzle 127, the wind flows from flow passage 350 into nozzle 127, which further accelerates the wind and directs the further accelerated wind to energy-extraction section 115.

An air cleaner 130 might be at the inlet 342 of each flow passage 332, within each flow passage 332, within flow passage 326, or within flow passage 350. Alternatively, air cleaner 130 might be in duct 125/nozzle 127 (FIG. 1), nozzle 240, diffuser 245, or exhaust duct 212 (FIG. 2). The wind is cleaned as it passes through air cleaner 130.

A signal from controller 190 might cause actuators 186 to increase the size of one or more flow passages 332, the size of flow passage 326 between deflector 324 and nozzle 322, the size of flow passage 350, the size of duct 125/nozzle 127, the size of converging nozzle 240, the size of diffuser 245, the size of throat 247, and/or the size of exhaust duct 212 in response to controller 190 receiving a signal from sensor 250 indicative of the air/wind velocity sensed by sensor 250 dropping below a certain level, receiving a signal from anemometer 192 indicative of the wind velocity sensed by anemometer 192 dropping below a certain level, and/or receiving a signal from generator 220 indicative of the power dropping below a certain level. For example, the increased the size of the one or more flow passages 332, of flow passage 326, of flow passage 350, of duct 125/nozzle 127, of converging nozzle 240, of diffuser 245, of throat 247, and/or of exhaust duct 212 might compensate for a reduction in the velocity and/or power output due to the added pressure drop due to the presence of an air cleaner 130 and/or due to a drop in the prevailing wind speed measured by anemometer 192, e.g., by increasing the flow velocity in the one or more flow passages 332, flow passage 326, flow passage 350, duct 125/nozzle 127, converging nozzle 240, diffuser 245, throat 247, and/or exhaust duct 212, and thus in the wind-energy conversion system. Note that the size of flow passage 326 between deflector 324 and nozzle 322 might be increased by causing the actuators 186 coupled to deflector 324 to decrease the size of deflector 324 in response to a signal from controller 190 and/or by causing the actuators 186 coupled to nozzle 322 to increase the size of nozzle 322 in response to a signal from controller 190.

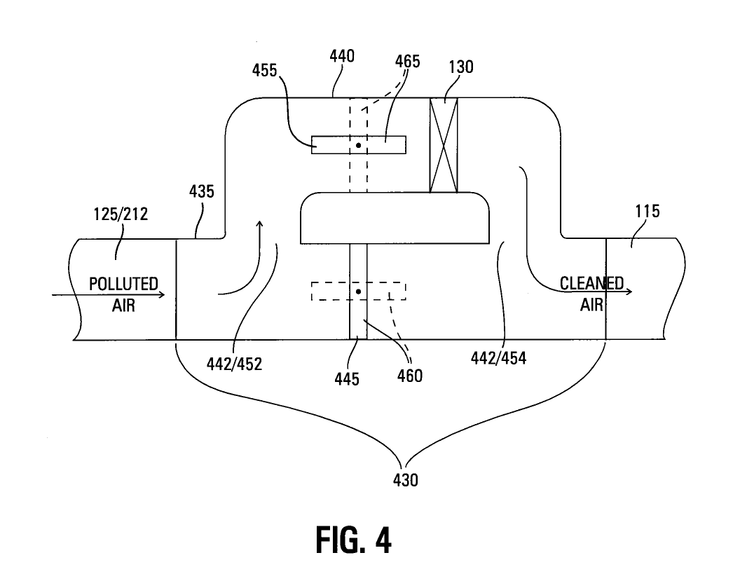

FIG. 4 illustrates an example of an air-cleaning system 430 that is configured to be activated and deactivated in response to a signal from controller 190. Air-cleaning system 430 may include an air cleaner 130. Air-cleaning system 430 might be between and fluidly coupled to duct 125 and energy-extraction section 115. Alternatively, air-cleaning system 430 might be fluidly coupled to and downstream of exhaust duct 212.

Air-cleaning system 430 includes a duct 435 fluidly coupled to a duct 440 by an inlet 442 of duct 440 that opens into duct 435 upstream of a valve 445 in duct 435 and by an outlet 450 of duct 440 that opens into duct 435 downstream of valve 445. Note that inlet 442 and outlet 450 of duct 440 can also be respectively referred to as outlet 452 and inlet 454 of duct 435.

A valve 455 is in duct 440 between inlet 442 and outlet 450 of duct 440. Air cleaner 130 might be in duct 440, downstream of valve 455, between valve 455 and outlet 450 of duct 440, as shown in FIG. 4.

Each of valves 445 and 455 may be communicatively coupled (e.g., electrically coupled, wirelessly coupled, etc.) to controller 190 for receiving a signal (e.g., an electrical signal over wires, a wireless signal, etc.) from controller 190. For example, valves 445 and 455 may be respectively configured to open and close ducts 435 and 440 in response to receiving a signal from controller 190.

In an example, valve 445 might include a diaphragm (e.g., a shutter) 460, such as a plate, configured to be pivoted by an actuator (e.g., a stepper motor) between the closed position, indicated by the solid line in FIG. 4, and the open position, indicated by the dashed line in FIG. 4, in response to the actuator receiving a signal from controller 190. That is, the actuator may be communicatively coupled (e.g., electrically coupled, wirelessly coupled, etc.) to controller 190 for receiving a signal (e.g., an electrical signal over wires, a wireless signal, etc.) from controller 190, for example. Valve 445 is open, and thus duct 435 is open, when diaphragm 460 is in the open position, and valve 445 is closed, and thus duct 435 is closed, when diaphragm 460 is in the closed position.

In an example, valve 455 might include a diaphragm (e.g., a shutter) 465, such as a plate, configured to be pivoted by an actuator (e.g., a stepper motor) between the open position, indicated by the solid line in FIG. 4, and the closed position, indicated by the dashed line in FIG. 4, in response to the actuator receiving a signal from controller 190. That is, the actuator may be communicatively coupled (e.g., electrically coupled, wirelessly coupled, etc.) to controller 190 for receiving a signal (e.g., an electrical signal over wires, a wireless signal, etc.) from controller 190, for example. Valve 455 is open, and thus duct 440 is open, when diaphragm 465 is in the open position, and valve 455 is closed, and thus duct 440 is closed, when diaphragm 465 is in the closed position. Note that air-cleaning system 430 might be configured such that valve 445 is closed while valve 455 is open and vice versa.

In the example of FIG. 4, valve 445, thus duct 435, is closed, and valve 455, and thus duct 440, is open. When air-cleaning system 430 is in this configuration, air-cleaning system 430 is activated, and polluted air (e.g., wind) is received in air-cleaning system 430 from duct 125 or exhaust duct 212 and is directed to air cleaner 130 through open valve 455. The polluted air is cleaned as it passes through air cleaner 130. The cleaned air, exiting air cleaner 130, is either directed to energy-extraction section 115, when the polluted air is received from duct 125, or exits the wind-energy conversion system, when the polluted air is received from exhaust duct 212.

When air-cleaning system 430 is activated, polluted air is passed through air cleaner 130. For example, air-cleaning system 430 may be activated in response to receiving a signal (e.g., an electrical signal over wires, a wireless signal, etc.) from controller 190 that causes valve 455 to open and valve 445 to close, e.g., concurrently. When air-cleaning system 430 is deactivated, polluted air is passed through duct 435 and bypasses air cleaner 130. For example, air-cleaning system 430 may be deactivated in response to receiving a signal from controller 190, e.g., that causes valve 455 to close and valve 445 to open, e.g., concurrently.

As used herein, multiple acts being performed concurrently will mean that each of these acts is performed for a respective time period, and each of these respective time periods overlaps, in part or in whole, with each of the remaining respective time periods. In other words, those acts are concurrently performed for at least some period of time.

When air-cleaning system 430 is activated and polluted air is passed through air cleaner 130, a drop in air pressure occurs across air cleaner 130 that can reduce the flow rate of the air through the wind-energy conversion system, causing energy-extraction section 115 to output less power. Therefore, controller 190 might be configured send a signal (e.g., an electrical signal over wires, a wireless signal, etc.) to air-cleaning system 430 that causes air-cleaning system 430 to deactivate in response to controller 190 receiving a signal (e.g., an electrical signal over wires, a wireless signal, etc.) from generator 220 indicative that the power output by the wind-energy conversion system is below a certain level, from anemometer 192 indicative that the prevailing wind speed external to the wind-energy conversion system is below a certain level, and/or from sensor 250 indicative that the air/wind velocity within the wind-energy conversion system is below a certain level. For example, the signal from controller 190 may be based on at least one of the prevailing wind speed external to the wind-energy conversion system, the flow velocity within the wind-energy conversion system, and the power output by the wind-energy conversion system.

Controller 190 might be configured send a signal to air-cleaning system 430 that causes air-cleaning system 430 to activate (e.g., reactivate) in response to controller 190 receiving a signal from generator 220 indicative that the power output by the wind-energy conversion system is above a certain level, from anemometer 192 indicative that the prevailing wind speed external to the wind-energy conversion system is above a certain level, and/or from sensor 250 indicative that the air/wind velocity within the wind-energy conversion system is above a certain level. That is, cleaning system 430 may be configured to be activated and deactivated based on the power output of the wind-energy conversion system, the prevailing wind speed external to the wind-energy conversion system, and/or the air/wind velocity within the wind-energy conversion system, for example. Controller 190 may be configured to determine whether the power output is above or below a certain level, the prevailing wind speed is above or below a certain level, and/or the air/wind velocity within the wind-energy conversion system is above or below a certain level.

Note that for some embodiments, air-cleaning system 430 might deactivated when increasing the size of nozzle 122, duct 125/nozzle 127, converging nozzle 240, diffuser 245, throat 247, and/or exhaust duct 212 (FIGS. 1 and 2), using actuators 186, or when increasing the size of one or more flow passages 332, flow passage 326, flow passage 350, duct 125/nozzle 127, converging nozzle 240, diffuser 245, throat 247, and/or exhaust duct 212 (FIGS. 2 and 3), using actuators 186, fail compensate for a reduction in the flow velocity within the wind-energy conversion system due to the added pressure drop, resulting from the air/wind passing through the air cleaner 130 in air-cleaning system 430, and/or due to a drop in the prevailing wind speed external to the wind-energy conversion system.

In alternate embodiments, instead of air cleaner 130 being located in duct 440, air cleaner 130 might be located in duct 435 downstream of valve 445, between valve 445 and inlet 454 of duct 435. In such embodiments, air-cleaning system 430 might be activated when valve 445, and thus duct 435, is open and valve 455, and thus duct 440, is closed, and air-cleaning system 430 might be deactivated when valve 445, and thus duct 435, is closed and valve 455, and thus duct 440, is open.

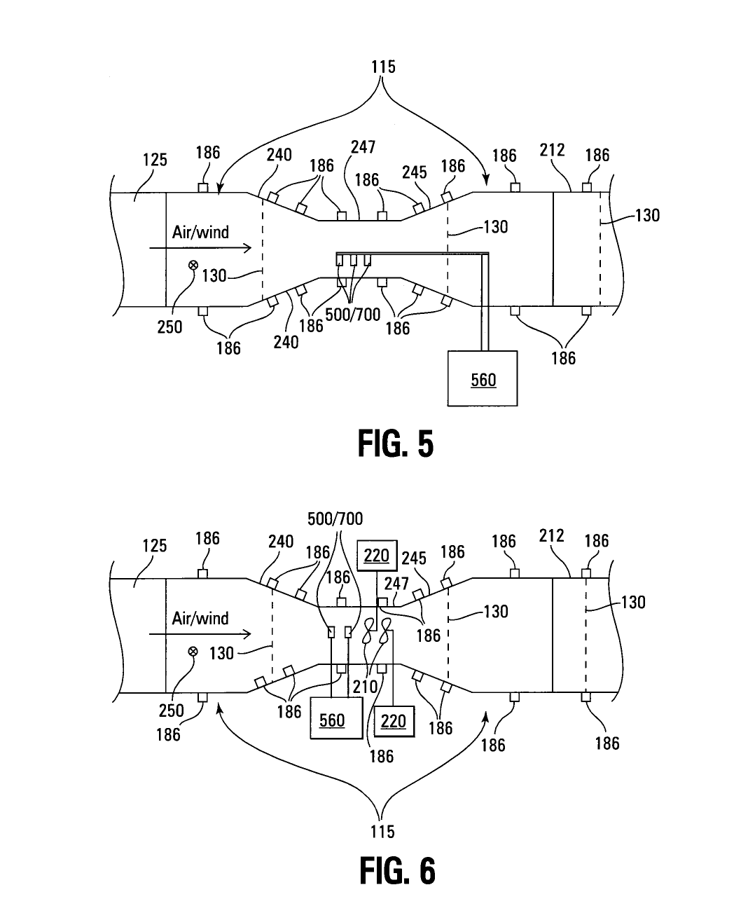

In the example of FIG. 5, the energy extractor in energy-extraction section 115 may include a vibratory generator 500 or a plurality of non-rotating vibratory generators 500 in series. Each generator 500 may include an electrical-charge-producing (e.g., a voltage-producing) material, such as a piezoelectric material. A generator 500 may be configured to vibrate in response to a fluid (e.g., to wind) flowing thereover, and the electrical-charge-producing material may be configured to produce an alternating electrical charge (e.g., voltage) in response to the generator 500 vibrating. The one or more generators 500 may replace the turbines 210 in the energy-extractor-section 115 in FIG. 2, for some embodiments. As such, one or more generators 500 may be between nozzle 240 and diffuser 245 in throat 247. Also note that common numbering is used in FIGS. 2, 5, and 6 to denote similar (e.g., the same) components, such as the components discussed above in conjunction with FIG. 2.

In the example of FIG. 6, the energy extractor in throat 247 of energy-extraction section 115 may include one or more turbines 210 in series with one or more non-rotating vibratory generators 500. For example, a plurality of turbines 210 in series may be in series with a plurality of non-rotating vibratory generators 500 in series. Where there is a plurality of turbines 210 in series, each turbine 210 may be individually coupled to a single electric generator 220, for some embodiments. In other embodiments, the plurality of turbines 210 in series coupled to a single generator 220, as shown in FIG. 2, may replace the turbines 210 individually coupled to single generators 220 in FIG. 6.

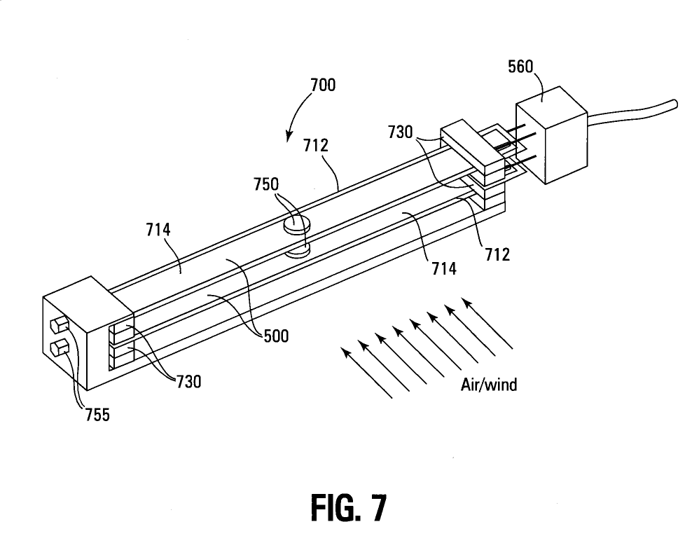

FIG. 7 is an example of a non-rotating-vibratory generator system 700 having one or more, such as a plurality (e.g. a stack) of, non-rotating vibratory generators 500. Each non-rotating vibratory generator 500 may have an electrical-charge-producing material 712 that may be interposed between a pair electrodes 714. A boundary constraint, such as an end boundary constraint 730, may be physically coupled to each generator 500. For example, an end boundary constraint 730 may be coupled to one or both ends of each generator 500. One or more masses 750 may be located on each generator 500. For example, masses 750 may be active masses, e.g., shape memory materials that can deform in response to an electrical current applied thereto, or passive masses. A tension adjuster 755 may be physically coupled to the end of each generator 500. For some embodiments, the energy extractor in energy-extraction section 115 may include a plurality of non-rotating-vibratory generator systems 700 in series, as shown in FIG. 5 or 6, or may include one or more non-rotating-vibratory generator systems 700 in series with one or more turbines 210, as shown in FIG. 6.

A controller 560 may be communicatively coupled (e.g., electrically by wires or wirelessly) to each generator 500 (FIGS. 5, 6, and 7) and to the boundary constraints, the active masses, and the tension adjuster 755 (FIG. 7). For example, controller 560 might include controller 190 so that controller includes the functionality of controller 190, as discussed above in conjunction with FIGS. 1-4.

Controller 560 may be configured to cause at least one of a stiffness of a boundary constraint, such as an end boundary constraint 730, a distribution of an active mass, and a tension exerted by a tension adjuster 755 on a generator 500 to be adjusted based on the prevailing wind as sensed by anemometer 192, the flow velocity of the air/wind flowing within the wind-energy conversion system (e.g., flow velocity of the air/wind flowing in duct 125 or in energy-extraction section 115 sensed by sensor 250), a power generated by one or more generators 500, e.g., determined by controller 560, and/or the power generated by electrical generator 220. A converter either separate from or incorporated in controller 560 may be electrically coupled to a generator 500 and may be configured to convert an AC voltage generated by the vibration of the generator 500 to DC voltage.

Note that for some embodiments, air-cleaning system 430 might deactivated in response to controller 560 determining that one or more generators 500 produce a power below a certain level. In other embodiments, increasing the size of nozzle 122, duct 125/nozzle 127, converging nozzle 240, diffuser 245, throat 247, and/or exhaust duct 212 (FIGS. 1 and 2), using actuators 186, or increasing the size of one or more flow passages 332, flow passage 326, flow passage 350, duct 125/nozzle 127, converging nozzle 240, diffuser 245, throat 247, and/or exhaust duct 212 (FIGS. 2 and 3), using actuators 186, might be in response to controller 560 determining that one or more generators 500 produce a power below a certain level. That is, for example, controller 560 might be communicatively coupled (e.g., electrically coupled, wirelessly coupled, etc.) to actuators 186 for sending a signal (e.g., an electrical signal over wires, a wireless signal, etc.) thereto.

In some embodiments, buildings may include wind-energy conversion systems, such as those discussed above in conjunction with FIGS. 1-7, that include an air cleaner 130 or an air-cleaning system 430. A wind-energy conversion system may be integrated in a building or may be adjacent to a building. For some embodiments, a space within the building may be part of the wind-energy conversion system and may be fluidly coupled to an energy extractor by a duct. Windows of the building that open to the space may serve as inlets to the wind-energy conversion system, for example.

A wind-energy conversion system may be installed in a building as part of the fabrication of the building or may be added to an existing building. Buildings that might include a wind-energy conversion system include single-family homes, multi-family apartments, office complexes, high-rises, (e.g., skyscrapers), industrial facilities, or any other buildings that require power.

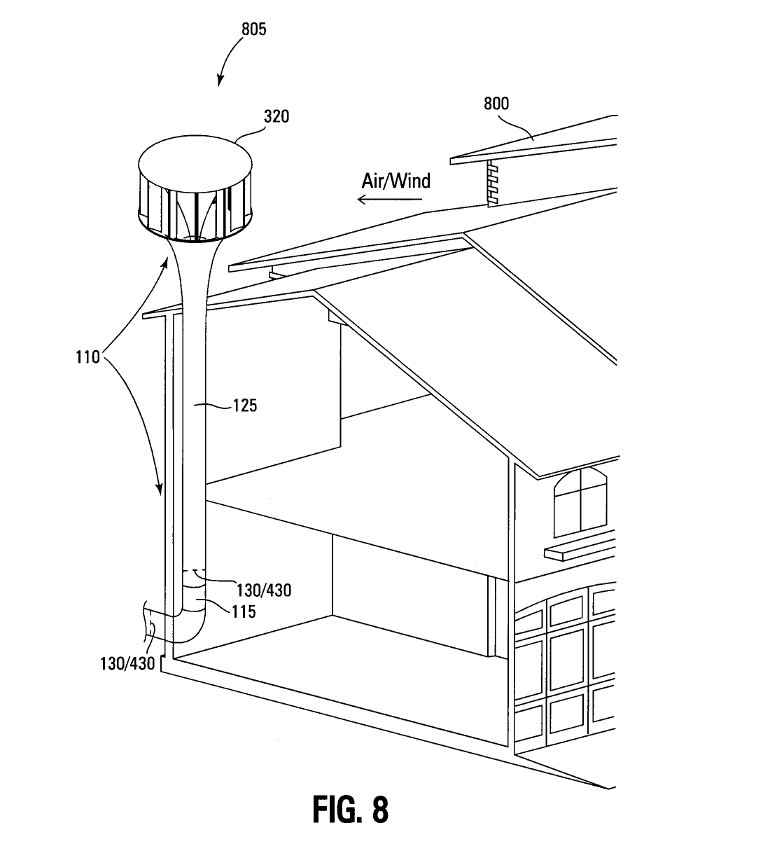

FIG. 8 is a cutaway perspective view of a building 800 that includes at least one wind-energy conversion system 805, such as discussed above in conjunction with FIGS. 1-7. For some embodiments, the building 800 may include a plurality of wind-energy conversion systems 805. The building 800 may be any type of building that requires power, such as, but not limited to, a home, an apartment complex, an office complex, a high-rise, an industrial facility, etc.

Wind-energy conversion system 805 may include the wind-delivery system 110 of FIG. 1 that may be fluidly coupled to the energy-extraction section 115 of FIG. 2, 5, or 6. Wind-delivery system 110 may include the nozzle assembly 320 of FIG. 3, as shown in FIG. 5, or the nozzle assembly 120 of FIG. 1, that is fluidly coupled to the duct 125 that is fluidly coupled to energy-extraction section 115.

Wind-energy conversion system 805 may include an air cleaner, such as air cleaner 130, or an air-cleaning system, such as the air-cleaning system 430 described above in conjunction with FIG. 4. For example, nozzle assembly 120 may include an air cleaner 130, as described above in conjunction with FIG. 1, and nozzle assembly 320 may include an air cleaner 130, as described above in conjunction with FIG. 3. Alternatively, energy-extraction section 115 may include an air cleaner 130, as described above in conjunction with FIG. 2 and shown in FIGS. 2, 5, and 6. For some embodiments, air-cleaning system 430 may be located between duct 125 and energy-extraction section 115 or downstream of energy-extraction section 115.

For some embodiments, wind-energy conversion system 805 may be fabricated as a part of a method for fabricating building 800. For other embodiments, wind-energy conversion system 805 may be installed after building 800 is fabricated, e.g., as an add-on.

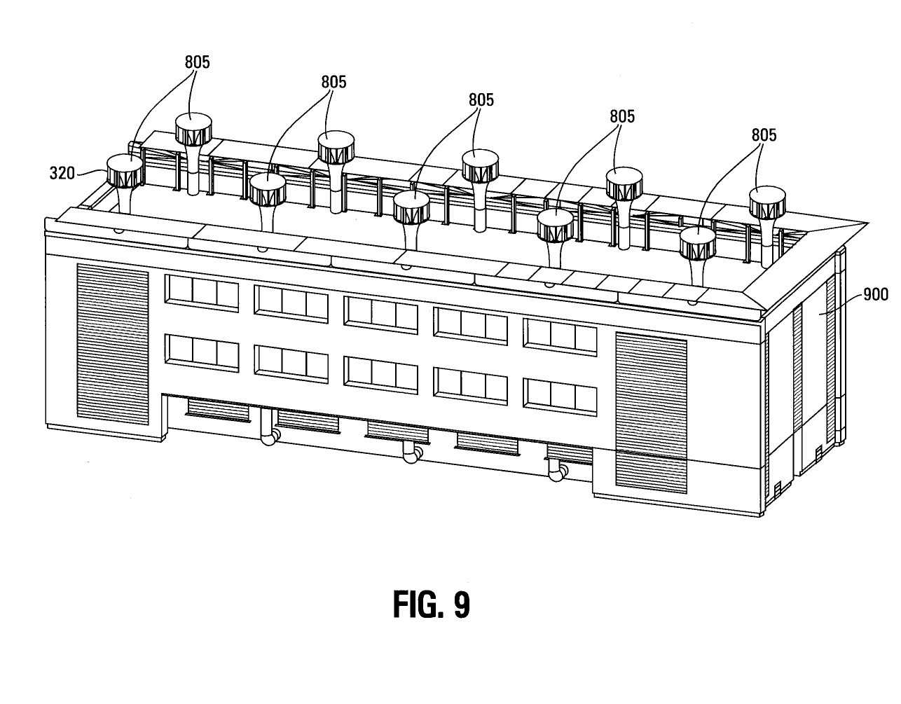

FIG. 9 is an example of a building 900 having a plurality of wind-energy conversion systems 805, e.g., each having a nozzle assembly 320. Each of the plurality of wind-energy conversion systems 805 might have an energy-extraction section 115 and an air cleaner 130 or an air-cleaning system 430. For other embodiments, the wind-delivery systems 110 of wind-energy conversion systems 805 in FIG. 9 might be fluidly coupled to a single energy-extraction section 115 that might include an air cleaner 130 or that might be fluidly coupled to a single air-cleaning system 430.

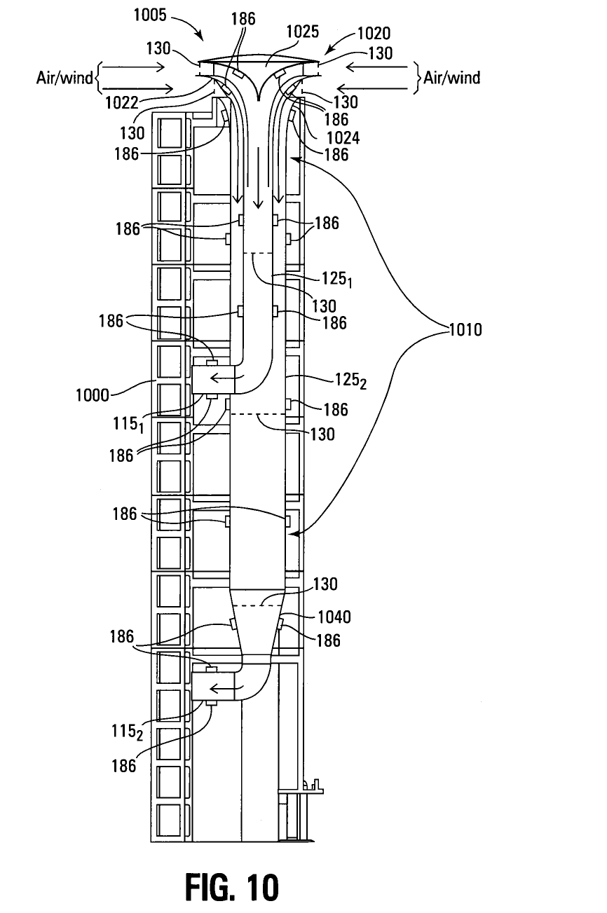

FIG. 10 illustrates a building 1000, such as high-rise building, having a wind-energy conversion system 1005. Wind-energy conversion system 1005 may be installed as part of a method of constructing building 1000 or installed after building 1000 is constructed, e.g., as a retrofit (e.g., as an add-on) to building 1000.

Wind-energy conversion system 1005 may include a wind-delivery system 1010 that may be fluidly coupled to energy-extraction sections 115 (e.g., energy-extraction sections 115₁ and 115₂), where each energy-extraction section 115 may be as discussed above in conjunction with FIGS. 2, 5, 6, and 7. Wind-energy conversion system 1005 may include an air cleaner, such as an air cleaner 130, or an air-cleaning system, such as the air-cleaning system 430 described above in conjunction with FIG. 4.

Each of energy-extraction sections 115₁ and 115₂ may include an air cleaner 130, as described above in conjunction with FIG. 2 and shown in FIGS. 2, 5, and 6. Each of energy-extraction sections 115₁ and 115₂ may include an energy extractor that may include one or more turbines 210, such as shown in FIGS. 2 and 6, one or more non-rotating vibratory generators 500, such as shown in FIGS. 5 and 6, one or more non-rotating-vibratory generator systems 700, such as shown in FIGS. 5-7, one or more turbines 210 and one or more non-rotating vibratory generators 500, such as shown in FIG. 6, or one or more turbines 210 and one or more non-rotating-vibratory generator systems 700, such as shown in FIG. 6.

Wind-delivery system 1010 of wind-energy conversion system 1005 may include a nozzle assembly 1020 that may include a vertical converging nozzle 1022 and a vertical converging nozzle 1024. Nozzle 1022 may extend into and may be coaxial with nozzle 1024. The inlet to nozzle 1022 is at a vertical level above the inlet to nozzle 1024. An air cleaner 130 might be at the inlet to nozzle 1022 and/or the inlet to nozzle 1024.

Actuators 186 may be coupled to (e.g., in direct physical contact with an outer surface of) nozzle 1022 and/or to (e.g., in direct physical contact with an outer surface of) nozzle 1024. These actuators 186 may be communicatively coupled (e.g., electrically by wires or wirelessly) to a controller, such as controller 190 described above in conjunction with FIGS. 1-4 or controller 560 (FIGS. 5-7), so that the actuators 186 can adjust the size and/or shape of nozzle 1022 and/or the size and/or shape of nozzle 1024 by exerting forces (e.g., directly) on the outer surface of nozzle 1022 and/or on the outer surface of nozzle 1024 in response to receiving a signal (e.g., an electrical signal over wires, a wireless signal, etc.) from the controller that is based on the prevailing wind speed external to wind-energy conversion system 1005, the flow velocity within wind-energy conversion system 1005, such as sensed by a sensor in ducts 125 or in energy-extraction sections 115 (e.g., sensor 250 shown in FIGS. 2, 5, and 6 and described above in conjunction with FIGS. 1-7), and/or the power output by energy-extraction sections 115₁ and 115₂.

An object, such as a deflector 1025, may extend into nozzle 1022 and may act to deflect the wind into nozzle 1022. For some embodiments, actuators 186 may be coupled to (e.g., in direct physical contact with an outer surface of) deflector 1025. These actuators 186 may be communicatively coupled (e.g., electrically by wires or wirelessly) to the controller, so that the actuators 186 can adjust the size and/or shape of deflector 1025 by exerting forces (e.g., directly) on the outer surface of deflector 1025 in response to receiving a signal (e.g., an electrical signal over wires, a wireless signal, etc.) from the controller that is based on the wind speed, the flow velocity within wind-energy conversion system 1005, such as sensed by the sensor in ducts 125 or in energy-extraction sections 115, and/or the power output by energy-extraction sections 115₁ and 115₂.

For some embodiments, nozzle 1022 may be fluidly coupled to duct 125₁ that may be fluidly coupled to energy-extraction section 115₁, and nozzle 1024 may be fluidly coupled to duct 125₂ that may be fluidly coupled to energy-extraction section 115₂. For some embodiments, a portion of duct 125₁ may be in duct 125₂ and may pass through a wall of duct 125₂ to couple to energy-extraction section 115₁, as shown in FIG. 10.

For example, ducts 125₁ and 125₂ might be independent of each other, e.g., the flow passages in ducts 125₁ and 125₂ might not be fluidly coupled to each other. As such, the energy extractors in energy-extraction sections 115₁ and 115₂ respectively fluidly coupled to ducts 125₁ and 125₂ might operate independently of each other.

Note that each of ducts 125₁ and 125₂ may be as described above in conjunction with FIGS. 1-4 and may include a converging nozzle 127 (FIG. 1) and may have actuators 186, on their outer surfaces that are communicatively coupled (e.g., electrically by wires or wirelessly) to the controller that is coupled to the actuators coupled to nozzles 1022 and/or 1024 and/or deflector 1025. These actuators 186 adjust the size and/or shape of ducts 125₁ and 125₂ by exerting forces (e.g., directly) on the outer surface of ducts 125₁ and 125₂ in response to receiving a signal (e.g., an electrical signal over wires, a wireless signal, etc.) from the controller that is based on the wind speed, the flow velocity within wind-energy conversion system 1005, such as sensed by a sensor in ducts 125 or in energy-extraction sections 115, and/or the power output by energy-extraction sections 115₁ and 115₂. An air cleaner 130 might be in each of ducts 125₁ and 125₂.

A nozzle 1040 may be between and fluidly coupled to duct 125₂ and energy-extraction section 115₂, for example. Actuators 186 may be coupled to (in direct physical contact with) an outer surface of nozzle 1040 and may be communicatively coupled (e.g., electrically by wires or wirelessly) to the controller. These actuators 186 adjust the size and/or shape of nozzle 1040 by exerting forces (e.g., directly) on the outer surface of nozzle 1040 in response to receiving a signal (e.g., an electrical signal over wires, a wireless signal, etc.) from the controller that is based on the wind speed, the flow velocity within wind-energy conversion system 1005, such as sensed by a sensor in ducts 125₂ or in energy-extraction section 115₂, and/or the power output by energy-extraction section 115₂. An air cleaner 130 might be in nozzle 130.

The energy extractors respectively in energy-extraction sections 115₁ and 115₂ might be at different vertical levels (e.g., might be on different floors) of building 1000. For example, the energy extractor in energy-extraction section 115₁ might be located on a floor that is above the floor on which the energy extractor in energy-extraction section 115₂ is located.

An air-cleaning system (not shown in FIG. 10), such as air-cleaning system 430 discussed above in conjunction with FIG. 4, might be between and fluidly coupled to duct 125₁ and energy-extraction section 115₁ and/or between and fluidly coupled to duct 125₂ and energy-extraction section 115₂. Alternatively, an air-cleaning system 430 might be fluidly coupled to and downstream of energy-extraction section 115₁ and/or energy-extraction section 115₂, as discussed above in conjunction with FIG. 4. For example, an exhaust duct, such as the exhaust duct 212 in FIGS. 2, 5, and 6, might be downstream of each of energy-extraction sections 115₁ and 115₂, and an air-cleaning system 430 might be downstream of and fluidly coupled to each exhaust duct. Each exhaust duct may be as described above for exhaust duct 212 in conjunction with FIG. 2 and may have actuators 186 (FIGS. 2 and 5-7) on its outer surface that are communicatively coupled (e.g., electrically by wires or wirelessly) to the controller that is coupled to the actuators 186 coupled to nozzles 1022 and 1024.

Note that each of energy-extraction sections 115₁ and 115₂ may be as described above in conjunction with FIGS. 2 and 5-7 and may have actuators 186 (FIGS. 2 and 5-7), coupled to their outer surfaces that are communicatively coupled (e.g., electrically by wires or wirelessly) to the controller that is coupled to the actuators 186 coupled to nozzles 1022 and 1024.

For some embodiments, wind-energy conversion system 1005 in building 1000 may be replaced with a wind-energy conversion system 808 that is described above in conjunction with (and shown in) FIG. 8.

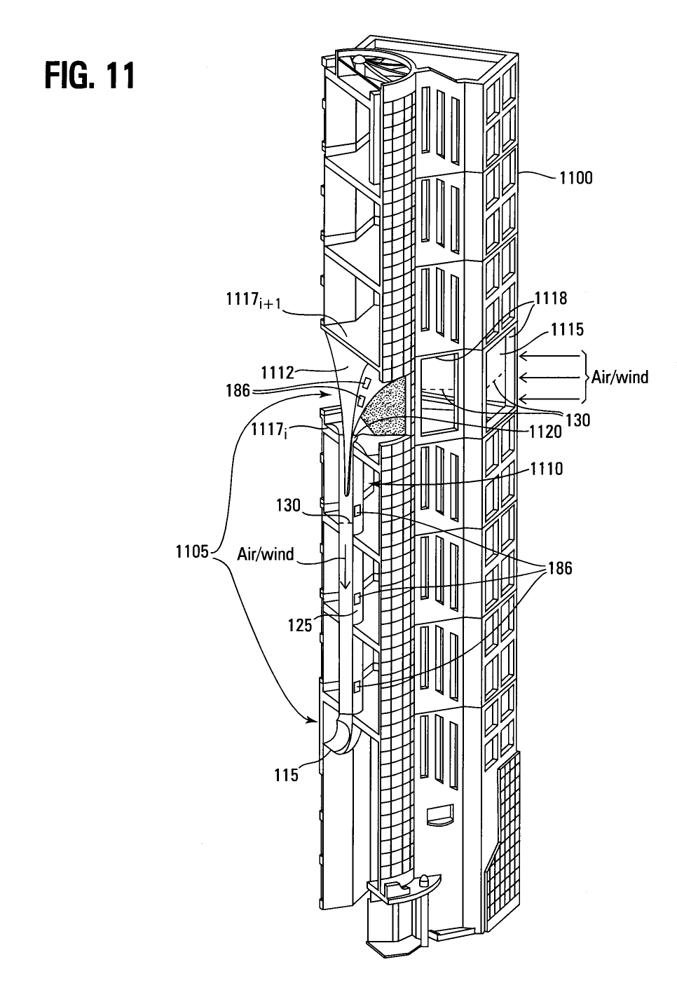

FIG. 11 illustrates a cut-away view of a building 1100, such as high-rise building, having a wind-energy conversion system 1105. Wind-energy conversion system 1105 may be installed as part of a method of constructing building 1100 or installed after building 1100 is constructed, e.g., as a retrofit (e.g., as an add-on) to building 1100.

For some embodiments, wind-energy conversion system 1105 may include a wind-delivery system 1110 that is fluidly coupled to an energy-extraction section 115, where energy-extraction section 115 may be as discussed above in conjunction with FIGS. 2, 5, and 6. For example, the energy-extraction section 115 of wind-energy conversion system 1105 may include one or more turbines 210, such as shown in FIGS. 2 and 6, one or more non-rotating vibratory generators 500, such as shown in FIGS. 5 and 6, one or more non-rotating-vibratory generator systems 700, such as shown in FIGS. 5-7, one or more turbines 210 and one or more non-rotating vibratory generators 500, such as shown in FIG. 6, or one or more turbines 210 and one or more non-rotating-vibratory generator systems 700, such as shown in FIG. 6. Energy-extraction section 115 may have an air cleaner 130, as described above in conjunction with FIG. 2 and shown in FIGS. 2, 5, and 6.

Wind-delivery system 1110 may include a duct 125 that may include a converging nozzle 127, as described above in conjunction with FIG. 1. For example, nozzle 127 may be a vertical converging nozzle that converges in the direction of the wind flow therethrough. For some embodiments, duct 125 may be at least a portion of or may be located in an elevator shaft of building 1100. Duct 125 is fluidly coupled to energy-extraction section 115. An object, such as a deflector 1112, may extend into duct 125 and may be configured to deflect wind into duct 125.

An air cleaner 130 may be in duct 125. Duct 125 may have actuators 186 on (e.g., coupled in direct physical contact with) its outer surface that are communicatively coupled (e.g., electrically by wires or wirelessly) to a controller, such as controller 190 (FIGS. 1 and 3) or controller 560 (FIGS. 5-7). Actuators 186 may be on (e.g., coupled in direct physical contact with) an outer surface of deflector 1112 and communicatively coupled (e.g., electrically by wires or wirelessly) to the controller. These actuators 186 adjust the size and/or shape of duct 125 and/or size and/or shape of deflector 1112 by exerting forces on the outer surface of duct 125 and/or deflector 1112 in response to receiving a signal (e.g., an electrical signal over wires, a wireless signal, etc.) from the controller that is based on the wind speed, the flow velocity within wind-energy conversion system 1105, such as sensed by a sensor in duct 125 or in energy-extraction section 115, and/or the power output by energy-extraction section 115.

Wind-delivery system 1110 may include a space (e.g., a story) 1115 of building 1100 between adjacent floors 1117ᵢ and 1117ᵢ₊₁. For example, story 1115 may be a service story and/or may be dedicated to ventilation and/or air conditioning of building 1100. Story 1115 may contain deflector 1112. A portion of deflector 1112 may extend through floor 1117ᵢ and into the story below story 1115 as deflector 1112 extends into duct 125, as shown in FIG. 11. Note that story 1115 may be several stories above ground level and may be an upper story of building 1100.

Wind may enter story 1115 through windows 1118 of story 1115. For example, windows 1118 may form inlets to wind-delivery system 1110, and thus to wind-energy conversion system 1105. For some embodiments, an air cleaner, such as air cleaner 130, might be located in the windows 1118 of story 1115.

For some embodiments, an inlet 1120 to duct 125 may be in the floor 1117ᵢ of story 1115. As such, duct 125 opens into and is fluidly coupled to story 1115. Duct 125 may extend downward from floor 1117ᵢ through one or more floors before reaching energy-extraction section 115. For example, energy-extraction section 115, and thus the energy extractor therein, maybe on a floor of building 1100 that is one or more floors (e.g., stories) of building below the inlet 1120 to duct 125, and thus story 1115. Duct 125 may fluidly couple story 1115 to energy-extraction section 115, and thus to the energy extractor in energy-extraction section 115.

An air-cleaning system 430 (not shown in FIG. 11) might be between and fluidly coupled to duct 125 and energy-extraction section 115, as discussed above in conjunction with FIG. 4. Alternatively, an air-cleaning system 430 might be fluidly coupled to and downstream of energy-extraction section 115, as discussed above in conjunction with FIG. 4. For example, an exhaust duct, such as the exhaust duct 212 in FIGS. 2, 5, and 6, might be downstream of energy-extraction section 115, and an air-cleaning system 430 might be downstream of and fluidly coupled to the exhaust duct. The exhaust duct may be as described above in conjunction with FIG. 2 and may have actuators 186 (FIGS. 2 and 5-7) on its outer surface that are communicatively coupled (e.g., electrically by wires or wirelessly) to the controller that is coupled to the actuators 186 coupled to duct 125 and/or deflector 1112.

### CONCLUSION

Although specific embodiments have been illustrated and described herein it is manifestly intended that the scope of the claimed subject matter be limited only by the following claims and equivalents thereof.

What is claimed is:

1. A wind-energy conversion system, comprising:
a wind-delivery system configured to accelerate wind;
an energy extractor configured to output energy in response to receiving the accelerated wind from the wind-delivery system; and
an air cleaner configured to clean the wind.

2. The wind-energy conversion system of claim 1, wherein the wind-energy conversion system is configured to adjust a size and/or shape of the wind-delivery system based on at least one of a prevailing wind speed external to the wind-energy conversion system, a flow velocity within the wind-energy conversion system, and a power output by the wind-energy conversion system.

3. The wind-energy conversion system of claim 1, wherein the air cleaner comprises at least one of a mechanical filter and an electrical filter.

4. The wind-energy conversion system of claim 3, wherein the mechanical filter comprises at least one of a HEPA filter and a carbon filter.

5. The wind-energy conversion system of claim 3, wherein the electrical filter comprises at least one of an electrostatic filter and an electronic filter.

6. The wind-energy conversion system of claim 1, further comprising an air-cleaning system, comprising the air cleaner, wherein the air-cleaning system is configured to direct the wind to the air cleaner when the air-cleaning system is activated and to cause the wind to bypass the air cleaner when the air-cleaning system is deactivated.

7. The wind-energy conversion system of claim 6, wherein the air-cleaning system is configured to be activated or deactivated in response to a signal from a controller of the wind-energy conversion system.

8. The wind-energy conversion system of claim 7, wherein the signal from the controller is based on at least one of a prevailing wind speed external to the wind-energy conversion system, a flow velocity within the wind-energy conversion system, and a power output by the wind-energy conversion system.

9. The wind-energy conversion system of claim 1, wherein the air cleaner is downstream of the energy extractor.

10. The wind-energy conversion system of claim 1, further comprising an energy-extraction section fluidly coupled to the wind-delivery system, the energy-extraction section comprising the energy extractor.

11. The wind-energy conversion system of claim 10, further comprising:
a controller; and
an actuator coupled to at least one of the wind-delivery system and the energy-extraction section;
wherein the actuator is configured to adjust a size and/or shape of the at least one of the wind-delivery system and the energy-extraction section in response to receiving a signal from the controller, wherein the signal is based on a prevailing wind speed external to the wind-energy conversion system, a flow velocity within the wind-energy conversion system, and/or a power output by the wind-energy conversion system.

12. The wind-energy conversion system of claim 10, wherein the air cleaner is in the energy-extraction section.

13. The wind-energy conversion system of claim 10, wherein the air cleaner is in a diffuser of the energy-extraction section downstream of the energy extractor or a nozzle of the energy-extraction section upstream of the energy extractor.

14. The wind-energy conversion system of claim 1, wherein the wind-delivery system comprises a horizontal nozzle fluidly coupled to a vertical nozzle.

15. The wind-energy conversion system of claim 14, wherein the air cleaner is in the horizontal nozzle or the vertical nozzle.

16. The wind-energy conversion system of claim 14, wherein an actuator is coupled to at least one of the vertical nozzle and the horizontal nozzle, wherein the actuator is configured to change a size and/or shape of the at least one of the vertical nozzle and the horizontal nozzle in response to receiving a signal from a controller of the wind-energy conversion system, wherein the signal is based on a prevailing wind speed external to the wind-energy conversion system, a flow velocity within the wind-energy conversion system, and/or a power output by the wind-energy conversion system.

17. The wind-energy conversion system of claim 1, wherein the wind-delivery system comprises a vertical nozzle.

18. The wind-energy conversion system of claim 17, wherein the vertical nozzle comprises a first vertical nozzle, and wherein the wind-delivery system comprises a second vertical nozzle fluidly coupled to the first vertical nozzle.

19. The wind-energy conversion system of claim 18, wherein the air cleaner is in the first vertical nozzle or in the second vertical nozzle.

20. The wind-energy conversion system of claim 17, wherein the wind-delivery system comprises a deflector that extends into the vertical nozzle.

21. The wind-energy conversion system of claim 20, further comprising:
a plurality of vanes between the deflector and the vertical nozzle; and
a plurality of flow passages, wherein each flow passage is between adjacent vanes of the plurality of vanes.

22. The wind-energy conversion system of claim 21, further comprising:
an actuator coupled to at least one of the vertical nozzle, the deflector, and each of the plurality of vanes; and
a controller communicatively coupled to the actuator coupled to the at least one of the vertical nozzle, the deflector, and each of the plurality of vanes;
wherein the controller is configured to send a signal to the actuator coupled to the at least one of the vertical nozzle, the deflector, and each of the plurality of vanes, wherein the signal is based on a prevailing wind speed external to the wind-energy conversion system, a flow velocity within the wind-energy conversion system, and/or a power output by the wind-energy conversion system.

23. The wind-energy conversion system of claim 22, wherein the actuator coupled to the at least one of the vertical nozzle, the deflector, and each of the plurality of vanes is configured to adjust a size and/or shape of at least one of the vertical nozzle, the deflector, and the plurality of flow passages in response to receiving the signal sent from the controller.

24. The wind-energy conversion system of claim 1, wherein the energy extractor comprises one or more turbines and/or one or more non-rotating generators.

25. The wind-energy conversion system of claim 24, wherein each of the one or more non-rotating generators is a vibratory non-rotating generator comprising an electrical-charge-producing material.

26. The wind-energy conversion system of claim 1, wherein the wind-energy conversion system is included in a building.

27. The wind-energy conversion system of claim 26, wherein the wind-delivery system comprises:
a space within the building, wherein one or more windows of the space are inlets to the wind-delivery system; and
a duct that opens to the space, wherein the duct fluidly couples the space to the energy extractor.

28. The wind-energy conversion system of claim 26, wherein the air cleaner is in the duct or in another duct downstream of and fluidly coupled to the energy extractor.

29. The wind-energy conversion system of claim 27, wherein the wind-delivery system further comprises a deflector that is located in the space and that extends into the duct.

30. The wind-energy conversion system of claim 1, wherein the energy extractor comprises a first energy extractor in a first energy-extraction section of the wind-energy conversion system and a second energy extractor in a second energy-extraction section of the wind-energy conversion system, wherein the wind-delivery system, comprises:
a first vertical converging nozzle fluidly coupled to the first energy-extraction section by a first duct;
a second vertical converging nozzle extending into the first vertical converging nozzle and fluidly coupled to the second energy-extraction section by a second duct; and
a deflector extending into the second vertical converging nozzle;
wherein the air cleaner comprises an air cleaner in the first duct and in the second duct or in the first energy-extraction section and in the second energy-extraction section.

31. A wind-energy conversion system, comprising:
a vertical nozzle;
a deflector extending into the vertical nozzle;
a turbine fluidly coupled to the vertical nozzle; and
an air cleaner fluidly coupled to the turbine.

32. The wind-energy conversion system of claim 31, wherein the air cleaner is downstream of the turbine.

33. The wind-energy conversion system of claim 31, further comprising a plurality of vanes between the vertical nozzle and the deflector.

34. The wind-energy conversion system of claim 31, wherein the turbine is in a throat of a Venturi tube that is fluidly coupled to the vertical nozzle.

35. The wind-energy conversion system of claim 34, wherein the wind-energy conversion system is configured to adjust a size and/or shape of at least one of the vertical nozzle, deflector, and Venturi tube based on at least one of a prevailing wind speed external to the wind-energy conversion system, a flow velocity within the wind-energy conversion system, and a power output by the wind-energy conversion system.

36. The wind-energy conversion system of claim 31, wherein the vertical nozzle comprises a first vertical nozzle, and further comprising a second vertical nozzle between and fluidly coupled to the turbine and the first vertical nozzle.

37. A wind-energy conversion system, comprising:
a turbine;
a horizontal nozzle;
a vertical nozzle between and fluidly coupled to the turbine and the horizontal nozzle; and
an air cleaner fluidly coupled to the turbine;
wherein the horizontal nozzle is configured to rotate relative to the vertical nozzle.

38. The wind-energy conversion system of claim 37, further comprising:
a controller; and
an actuator coupled to an outer surface of the horizontal nozzle, wherein the actuator is configured adjust the size and/or shape of the horizontal nozzle in response to receiving a signal from the controller that is based on at least one of a prevailing wind speed external to the wind-energy conversion system, a flow velocity within the wind-energy conversion system, and a power output by the wind-energy conversion system.

39. The wind-energy conversion system of claim 38, wherein the actuator is coupled in direct physical contact with the outer surface of the horizontal nozzle, wherein the actuator is configured to a exert force, in response to receiving the signal from the controller, on the outer surface of the horizontal nozzle that changes the size and/or shape of the horizontal nozzle.

40. The wind-energy conversion system of claim 38, further comprising:
an actuator coupled to an outer surface of the vertical nozzle, wherein the actuator is configured adjust the size and/or shape of the vertical nozzle in response to receiving a signal from the controller that is based on at least one of the prevailing wind speed external to the wind-energy conversion system, the flow velocity within the wind-energy conversion system, and the power output by the wind-energy conversion system.

41. The wind-energy conversion system of claim 37, wherein the air cleaner is in the horizontal nozzle, the vertical nozzle, or in a duct downstream of the turbine.
